(19) United States
(12) Patent Application Publication
(10) Pub. No.: US 2009/0104008 A1
(43) Pub. Date: Apr. 23, 2009

(54) Recess Anchor Box CLE-RAB

(76) Inventor: Terry Allan Leach, Middleburg, FL (US)

Correspondence Address: WILSON DANIEL SWAYZE, JR., 3804 CLEARWATER CT., PLANO, TX, 75025, US

(21) Appl. No.: 11/875,885

(22) Filed: Oct. 20, 2007

(51) Int. Cl. B65G 41/00

(52) U.S. Cl. 414/402

(57) ABSTRACT

An anchor box for being placed in a solid structure includes a housing member for providing housing for the anchor box and an anchor member connected to the housing member and extending to the solid structure. The anchor member may extend through a side of the housing member, and the anchor member may include a curved portion. The anchor member may include an angled portion, and the anchor member may include a longitudinal portion. The curved portion of the anchor member may be enclosed by the housing member, and a section of the angled portion of the anchor member may be enclosed by the housing member. A longitudinal portion of the anchor member may be external to the housing member, and the housing member may include a depression member to secure the housing member within the solid structure. The housing member may include a outwardly projecting member, and the housing member may include a peripheral lip around a front member of the housing member. The solid structure may be concrete.

### FIELD OF THE INVENTION

The present invention relates to a load lifting apparatus which is suitable for use in material handling operations, for example carrying loads, which enables loads of various shapes and structures to be readily moved and to be easily released.

### BACKGROUND OF THE INVENTION

To lift and to move a heavy load for example a concrete block or pipe to a desired position are usually desired at a construction site, particularly a construction site of a road or large building. To lift and to move the heavy load, a wire rope or chain may be wound around the load, and the other end of the wire rope or chain may be engaged with a hook of the material-handling equipment. In this state, the load is lifted and moved to the desired position, and then, the wire rope or chain is removed from the load. Alternatively, some loads are lifted and moved to a desired position through the use of an engagement member such as a bolt or hook having been previously attached to the load. Under these circumstances, a wire rope or chain is attached to the engagement member, and the other end of the wire rope or chain is attached to a hook of the material-handling equipment. The material-handling equipment may move the load to the desired location, and then after the load has been moved to the desired location, the wire rope is disengaged from the engagement member which has been attached to the load.

The material-handling equipment, for example a crane, may have a clamping apparatus for clamping to the load to be lifted. This clamping apparatus may be opened by human power or by using a jig for example a hydraulic device to pick up the load to be lifted.

One such clamping device is described in U.S. Pat. No. 6,286,881 where a load lifting apparatus is disclosed that is suitable for use in material-handling operations to enable loads of various shapes and structures for example concrete products to be clamped and released.

Another lifting apparatus is described in U.S. Pat. No. 3,300,062 that describes a lifting apparatus which is capable of lifting pre-cast concrete walls. This patent describes a lifting apparatus having a weight distributing or load spreading units in combination with a lifting unit.

A further lifting apparatus is described in U.S. Pat. No. 2,589,954 that describes a lifting apparatus for lifting and conveying or moving concrete wall slabs. This lifting apparatus allows a concrete wall slab to be raised from a flat or horizontal position to substantially upright position.

### SUMMARY OF THE INVENTION

It is an object of the invention to provide a lifting apparatus which is capable of efficiently raising a load such as walls, boxes, cylinders and pipes formed from concrete or a similar type of material.

It is an object of the present invention to provide a lifting apparatus which is of compact and lightweight construction and can be formed with the load.

It is an object of the present invention to provide a lifting apparatus which may include an anchor to be formed with concrete or the similar material.

An anchor box for being placed in a solid structure includes a housing member for providing housing for the anchor box and an anchor member connected to the housing member and extending to the solid structure.

The anchor member may extend through a side of the housing member, and the anchor member may include a curved portion.

The anchor member may include an angled portion, and the anchor member may include a longitudinal portion.

The curved portion of the anchor member may be enclosed by the housing member, and a section of the angled portion of the anchor member may be enclosed by the housing member.

A longitudinal portion of the anchor member may be external to the housing member, and the housing member may include a depression member to secure the housing member within the solid structure.

The housing member may include a outwardly projecting member, and the housing member may include a peripheral lip around a front member of the housing member.

The solid structure may be concrete.

### BRIEF DESCRIPTION OF THE DRAWINGS

The invention may be understood by reference to the following description taken in conjunction with the accompanying drawings, in which, like reference numerals identify like elements, and in which:

FIG. 1 illustrates a cross-sectional view of a side of the anchor box;

FIG. 2 illustrates a cross-sectional view of the anchor to be used in conjunction with the anchor box;

FIG. 3 illustrates a cross-sectional view of the front of the anchor box an anchor of the present invention;

FIG. 4 illustrates a cross-sectional view of the back of the anchor box and anchor of the present invention;

FIG. 5 illustrates a cross-sectional view of the top of the anchor box and anchor of the present invention;

FIG. 6 illustrates a bottom view of the anchor box and anchor of the present invention;

FIG. 7 illustrates a cross-sectional view of the anchor box and anchor in concrete.

### DETAILED DESCRIPTION

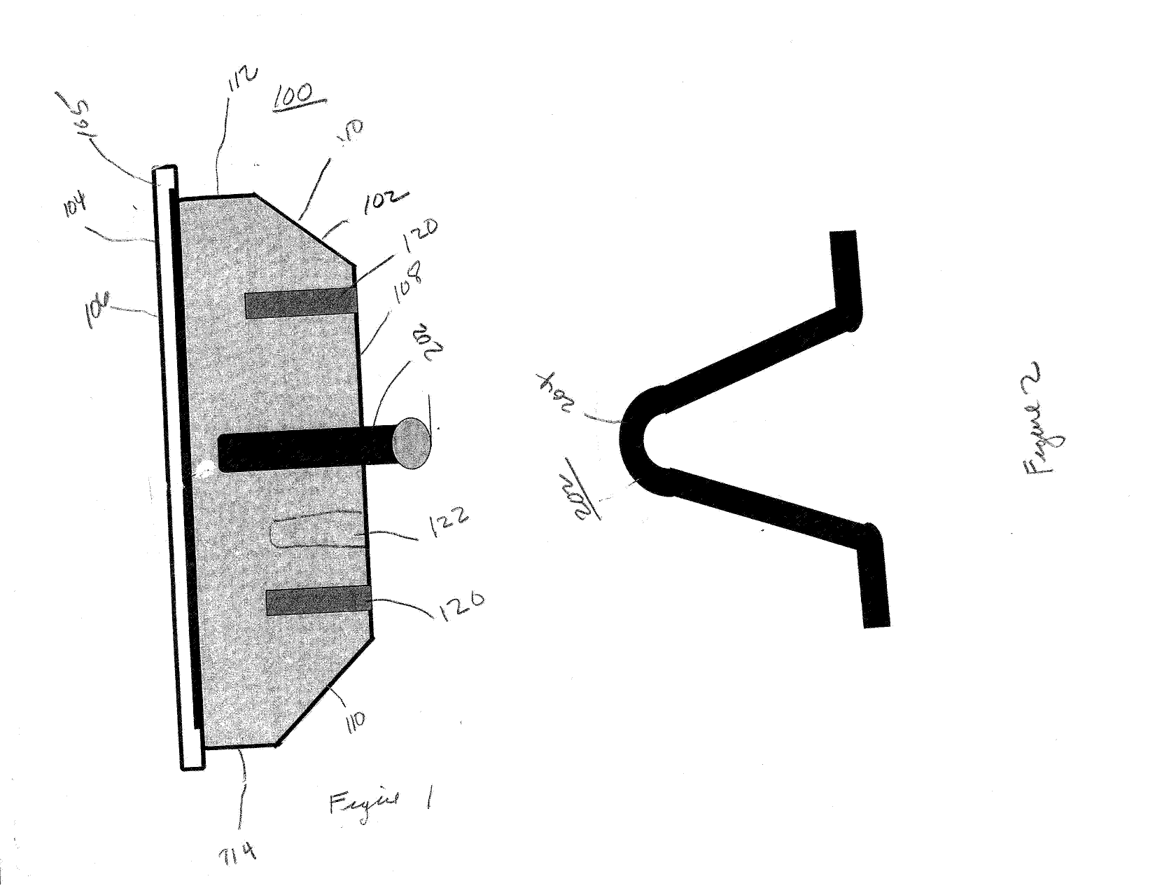

FIG. 1 illustrates the anchor box 100 which includes an anchor housing member 102 to house the anchor member 202 of the present invention and to provide a lifting point for a load. The anchor housing member 102 includes a front housing member 104 which includes a front detachable member 106 which is removable to allow the anchor member 202 to be placed into wet concrete or other suitable solid structure without contaminating the interior of the anchor housing member 102 while in place and to be removed to allow access to the anchor member 202. The front housing member 104 includes a peripheral lip member 105 which extends around the periphery of the anchor housing member 102. The anchor housing member 102 additionally includes a back member 108, an opposing inclined member 110, a top member 112, a bottom member 114 and side members 116. The anchor housing member 102 may be formed from flexible material such as plastic but could be formed from rigid material such as thin steel.

FIG. 1 additionally illustrates a depression member 120 which forms a depression within the anchor housing member 102 and an outwardly projecting member 122 which extends outwards from the anchor housing member 102 to stabilize the anchor housing member of 102 when the anchor housing member of 102 is placed within concrete.

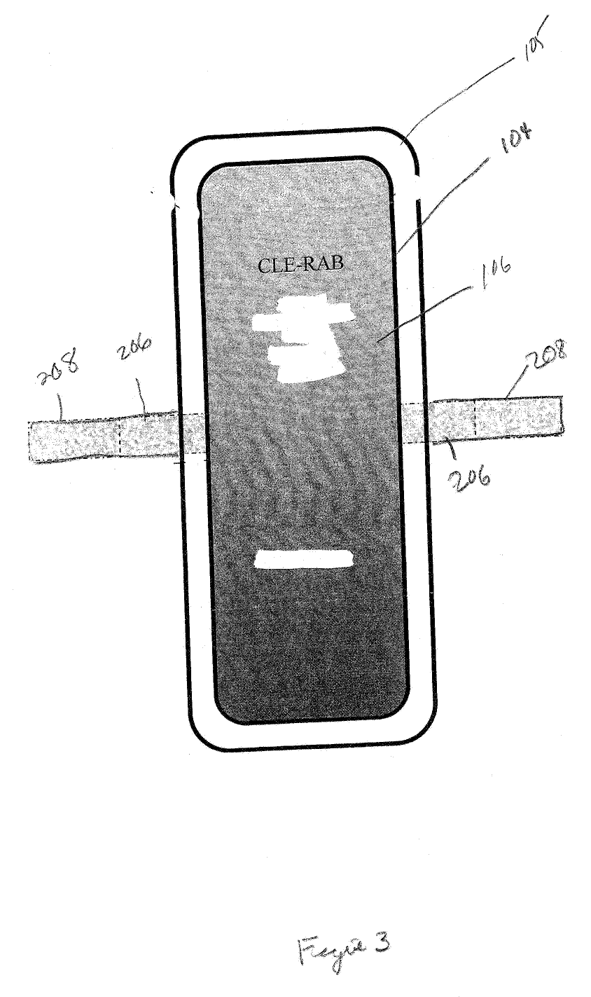

FIG. 2 illustrates the anchor member 202 of the present invention. The anchor member 202 includes a curved portion 204 which forms an attachment position for a rope, a hook, a wire or other device in order to lift the anchor box 100 of the present invention and the load which may be a pipe or wall or any such apparatus to be carried. The anchor member 202 includes a pair of angled portions 206 which are connected to each end of the curved portion 204 and a longitudinal portion 208 which is connected to the end of the angled portion 206. The curved portion 204 and a section of the angled portion 206 are positioned within the interior of the anchor housing member 102. The angled portion 206 extends through the side member 116 and a section of the angle portion 206 and the longitudinal portion 208 are exterior to the anchor housing member of 102 and are encased by the concrete to prevent the anchor housing member 102 from moving with respect to the concrete.

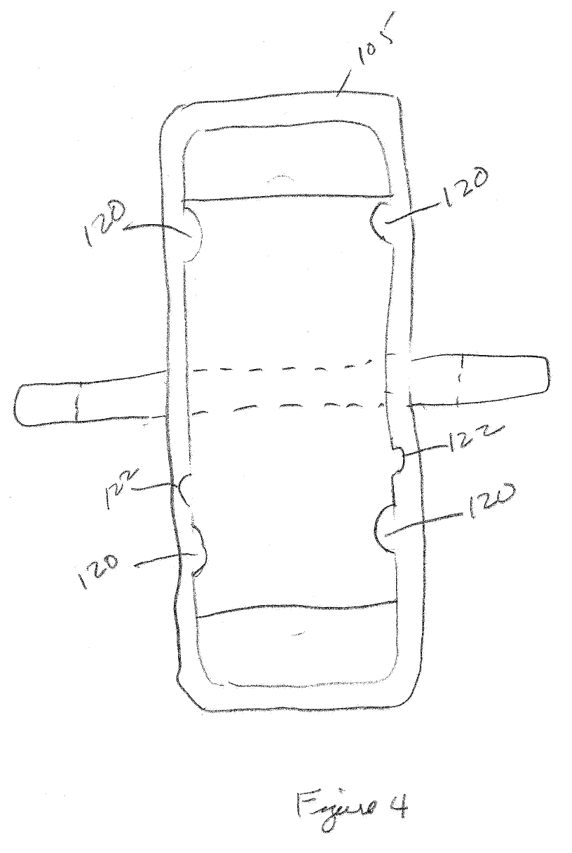

FIG. 3 illustrates a front view of the anchor housing member 102 and shows the front member 104 and the front detachable member 106.

Additionally, FIG. 3 illustrates a portion of the angled portion 206 and the longitudinal portion 208 of the anchor member 202.

FIG. 4 illustrates a back view of the anchor housing member 102 and shows the peripheral lip member 105 and the back member 108. Additionally FIG. 4 shows the depression member 102 formed in the side member 116 and the outwardly projecting member 122 formed in the side member 116.

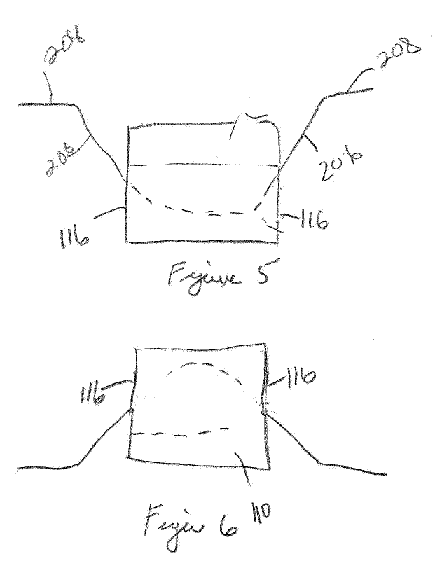

FIG. 5 illustrates a top view of the anchor housing member 102 with the angled portion 206 of the anchor member 202 extending through the side member 116.

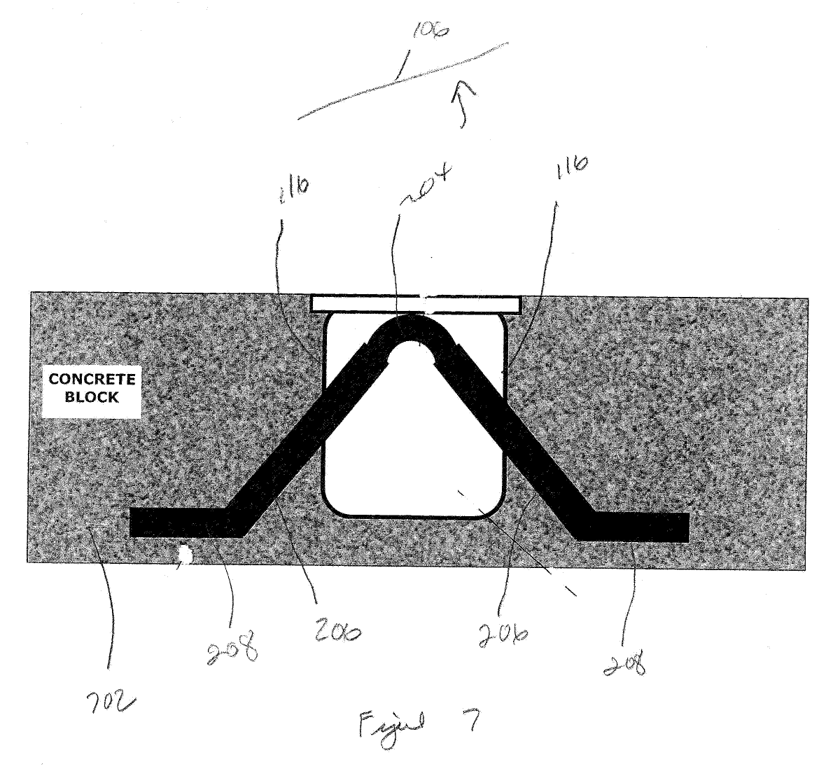

FIG. 6 illustrates a bottom view of the anchor housing member of 102 with the angle portion 206 of the anchor member 202 extending to the side member 116.

FIG. 7 illustrates a side view of the anchor member 202 and housing member 102 in concrete 702. The front detachable member 106 has been removed from the front member 104 so that access can be obtained to the curved portion 204 for lifting the concrete 702. FIG. 7 illustrates the angled portion 206 and the longitudinal portion 208 of the anchor member 202. The angled portion 206 extends through the side member 116 of the housing member 102.

While the invention is susceptible to various modifications and alternative forms, specific embodiments thereof have been shown by way of example in the drawings and are herein described in detail. It should be understood, however, that the description herein of specific embodiments is not intended to limit the invention to the particular forms disclosed.

1) An anchor box for being placed in a solid structure, comprising:
a housing member for providing housing for the anchor box;
an anchor member connected to the housing member and extending to the solid structure.

2) An anchor box for being placed in a solid structure as in claim 1, wherein the anchor member extends through a side of the housing member.

3) An anchor box for being placed in a solid structure as in claim 1, wherein the anchor member includes a curved portion.

4) An anchor box for being placed in a solid structure as in claim 1, wherein the anchor member includes a angled portion.

5) An anchor box for being placed in a solid structure as in claim 1, wherein the anchor member includes a longitudinal portion.

6) An anchor box for being placed in a solid structure as in claim 3, wherein the curved portion of the anchor member is enclosed by the housing member.

7) An anchor box for being placed in a solid structure as in claim 4, wherein a section of the angled portion of the anchor member is enclosed by the housing member.

8) An anchor box for being placed in a solid structure as in claim 5, wherein a longitudinal portion of the anchor member is external to the housing member.

9) An anchor box for being placed in a solid structure as in claim 1, wherein the housing member includes a depression member to secure the housing member within the solid structure.

10) An anchor box for being placed in a solid structure as in claim 1, wherein the housing member includes a outwardly projecting member.

11) An anchor box for being placed in a solid structure as in claim 1, wherein the housing member includes a peripheral lip around a front member of the housing member.

12) An anchor box for being placed in a solid structure as in claim 1, wherein the solid structure is concrete.
